(19) United States
(12) Patent Application Publication
(10) Pub. No.: US 2018/0091447 A1
(43) Pub. Date: Mar. 29, 2018

(54) TECHNOLOGIES FOR DYNAMICALLY TRANSITIONING NETWORK TRAFFIC HOST BUFFER QUEUES

(71) Applicant: Intel Corporation, Santa Clara, CA (US)

(72) Inventors: Matthew A. Jared, Hillsboro, OR (US); Duke C. Hong, Hillsboro, OR (US); Manasi Deval, Portland, OR (US)

(21) Appl. No.: 15/274,337

(22) Filed: Sep. 23, 2016

(51) Int. Cl. H04L 12/861; H04L 12/869; H04L 12/801; H04L 12/26

(52) U.S. Cl. CPC H04L 49/9005; H04L 43/08; H04L 47/11; H04L 47/58

(57) ABSTRACT

Technologies for dynamically transitioning network traffic host buffers of a network computing device include the software abstraction of one or more hardware queues of the network computing device based on a network flow type associated with network traffic received by the network computing device. The network computing device is configured to identify a queue transition event, completing pending transactions in one or more of the software abstracted queues, and transition the abstracted queues to handle the flow type associated with the queue transition event. Additionally, the network computing device is configured to realign the abstracted queues to be associated with one or more hardware components of the network computing device based on the second network traffic flow type, provide a ready indication to a client associated with the abstracted queues that indicates the abstracted queues are ready for polling, and process received network traffic associated with the second network traffic flow type in the abstracted queues. Other embodiments are described herein.

### BACKGROUND

Network operators and service providers typically rely on various network virtualization technologies to manage complex, large-scale computing environments, such as high-performance computing (HPC) and cloud computing environments. For example, network operators and service provider networks may rely on network function virtualization (NFV) deployments to deploy network services (e.g., firewall services, network address translation (NAT) services, load balancers, deep packet inspection (DPI) services, evolved packet core (EPC) services, mobility management entity (MME) services, packet data network gateway (PGW) services, serving gateway (SGW) services, billing services, transmission control protocol (TCP) optimization services, etc.). Such NFV deployments typically use an NFV infrastructure to orchestrate various virtual machines (VMs) to perform virtualized network services, commonly referred to as virtualized network functions (VNFs), on network traffic and to manage the network traffic across the various VMs.

Unlike traditional, non-virtualized deployments, virtualized deployments decouple network functions from underlying hardware, which results in network functions and services that are highly dynamic and generally capable of being executed on off-the-shelf servers with general purpose processors. As such, the VNFs can be scaled-in/out as necessary based on particular functions or network services to be performed on the network traffic. Accordingly, NFV deployments typically require greater performance and flexibility requirements. Various network I/O architectures have been created, such as the Packet Direct Processing Interface (PDPI), Message Signaled Interrupts (MSI-x), etc. However, such network I/O architectures can use different mechanisms to process network traffic. For example, PDPI consists of host buffer passing up and down the software stack via Network Buffer Lists (NBLs); whereas traditional MSI-x relies on interrupt driven buffer management using a polling mechanism.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for dynamically transitioning network host buffer queues that includes one or more network computing devices;

FIG. 2 is a simplified block diagram of a typical input/output (I/O) design of present network computing devices of the system of FIG. 1;

FIG. 3 is a simplified block diagram of at least one embodiment of an I/O design of a network computing device of the system of FIG. 1;

FIG. 4 is a simplified block diagram of at least one embodiment of an environment of the network computing device of FIG. 3;

FIG. 5 is a simplified flow diagram of at least one embodiment of a method for allocating host buffer queues for network traffic processing that may be executed by the network computing device of FIGS. 3 and 4; and

FIG. 6 is a simplified flow diagram of at least one embodiment of a method for dynamically transitioning network traffic host buffer queues that may be executed by the network computing device of FIGS. 3 and 4.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C): (A and B); (A and C); (B and C); or (A, B, and C). Similarly, items listed in the form of “at least one of A, B, or C” can mean (A); (B); (C): (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

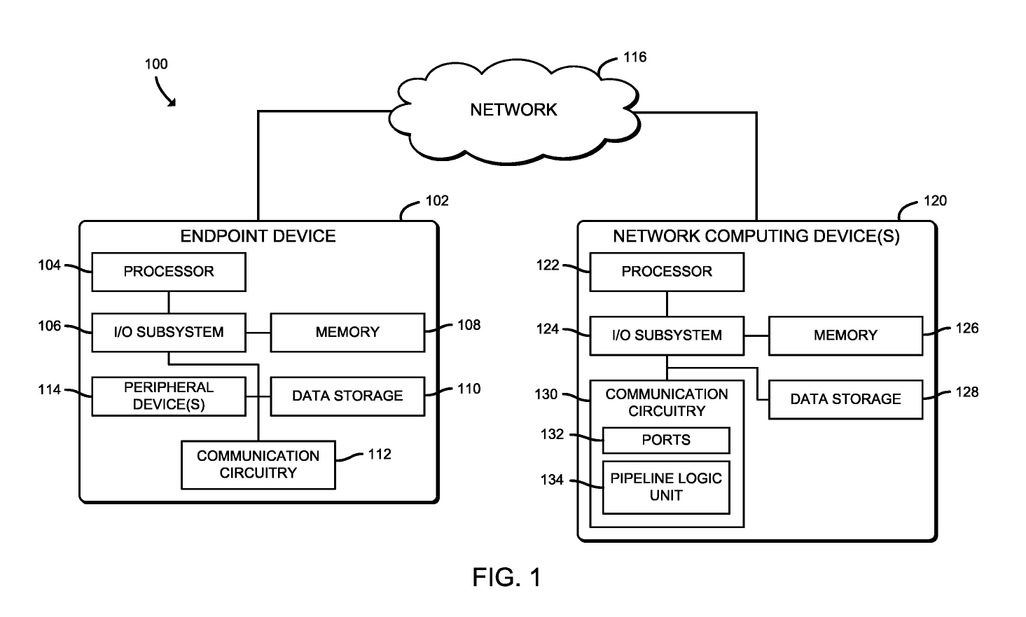

Referring now to FIG. 1, in an illustrative embodiment, a system 100 for dynamically transitioning network traffic host buffer queues includes an endpoint device 102 in network communication with one or more network computing devices 120 via a network 116. In use, as will be discussed in further detail, the endpoint device 102 requests information (e.g., data) via a networked client application (e.g., an internet of things (IoT) application, an enterprise application, a cloud-based application, a mobile device application, etc.). Network traffic related to the request and/or the response, as well as the data contained therein, may be processed by one or more of the network computing devices 120.

As the network traffic (e.g., a network packet, a message, etc.) is received by the respective network computing device 120, the network computing device 120 is configured to process the network traffic. For example, the network computing device 120 may be configured to perform a service, or function, on the network traffic. Such services may include firewall services, network address translation (NAT) services, load balancers, deep packet inspection (DPI) services, evolved packet core (EPC) services, mobility management entity (MME) services, packet data network gateway (PGW) services, serving gateway (SGW) services, billing services, transmission control protocol (TCP) optimization services, etc.

Accordingly, the network computing device 120 is configured to manage memory buffers, and the queues thereof, to enable the operating system to switch (i.e., transition) between two dissimilar network traffic flows (e.g., Packet Direct Processing Interface (PDPI), Message Signaled Interrupts (MSI-x) flow), such as may be varied by processing mechanism, workload type, destination computing device, etc., without reallocating memory and/or resetting/re-initializing network hardware. To transition the queues, the network computing device 120 is configured to allocate software-based queues abstracted from previously allocated hardware queues, which may be assigned to either the driver or a PDPI client, depending on the present configuration of the queues, such as may be based on the network flow type. Additionally, the network computing device 120 is configured to coordinate the transition with all of the affected technologies and hardware interfaces (e.g., handle interrupt causes, configure queue contexts, assign user priorities, assign traffic classic, interface with the operating system, make hardware configuration adjustments, etc.) such that the network traffic may be processed until the transition has been completed.

The endpoint device 102 may be embodied as any type of computation or computer device capable of performing the functions described herein, including, without limitation, a smartphone, a mobile computing device, a tablet computer, a laptop computer, a notebook computer, a computer, a server (e.g., stand-alone, rack-mounted, blade, etc.), a network appliance (e.g., physical or virtual), a web appliance, a distributed computing system, a processor-based system, and/or a multiprocessor system. As shown in FIG. 1, the illustrative endpoint device includes a processor 104, an input/output (I/O) subsystem 106, a memory 108, a data storage device 110, communication circuitry 112, and one or more peripheral devices 114. Of course, in other embodiments, the endpoint device 102 may include alternative or additional components, such as those commonly found in a computing device capable of communicating with a telecommunications infrastructure (e.g., various input/output devices). Additionally, in some embodiments, one or more of the illustrative components may be incorporated in, or otherwise form a portion of, another component. For example, the memory 108, or portions thereof, may be incorporated into the processor 104, in some embodiments. Further, in some embodiments, one or more of the illustrative components may be omitted from the endpoint device 102.

The processor 104 may be embodied as any type of processor capable of performing the functions described herein. For example, the processor 104 may be embodied as one or more single core processors, on or more multi-core processors, a digital signal processor, a microcontroller, or other processor or processing/controlling circuit. Similarly, the memory 108 may be embodied as any type of volatile or non-volatile memory or data storage capable of performing the functions described herein. In operation, the memory 108 may store various data and software used during operation of the endpoint device 102, such as operating systems, applications, programs, libraries, and drivers.

The memory 108 is communicatively coupled to the processor 104 via the I/O subsystem 106, which may be embodied as circuitry and/or components to facilitate input/output operations with the processor 104, the memory 108, and other components of the endpoint device 102. For example, the I/O subsystem 106 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 106 may form a portion of a system-on-a-chip (SoC) and be incorporated, along with the processor 104, the memory 108, and other components of the endpoint device 102, on a single integrated circuit chip.

The data storage device 110 may be embodied as any type of device or devices configured for short-term or long-term storage of data such as, for example, memory devices and circuits, memory cards, hard disk drives, solid-state drives, or other data storage devices. It should be appreciated that the data storage device 110 and/or the memory 108 (e.g., the computer-readable storage media) may store various data as described herein, including operating systems, applications, programs, libraries, drivers, instructions, etc., capable of being executed by a processor (e.g., the processor 104) of the endpoint device 102.

The communication circuitry 112 may be embodied as any communication circuit, device, or collection thereof, capable of enabling communications between the endpoint device 102 and other computing devices, such as the network computing devices 120, as well as any network communication enabling devices, such as an access point, network switch/router, etc., to allow communication over the network 116. The communication circuitry 112 may be configured to use any one or more communication technologies (e.g., wireless or wired communication technologies) and associated protocols (e.g., Ethernet, Bluetooth®, Wi-Fi®, WiMAX, LTE, 5G, etc.) to effect such communication.

The network 116 may be embodied as any type of wired or wireless communication network, including a wireless local area network (WLAN), a wireless personal area network (WPAN), a cellular network (e.g., Global System for Mobile Communications (GSM), Long-Term Evolution (LTE), etc.), a telephony network, a digital subscriber line (DSL) network, a cable network, a local area network (LAN), a wide area network (WAN), a global network (e.g., the Internet), or any combination thereof. It should be appreciated that, in such embodiments, the network 116 may serve as a centralized network and, in some embodiments, may be communicatively coupled to another network (e.g., the Internet). Accordingly, the network 116 may include a variety of other virtual and/or physical network computing devices (e.g., routers, switches, network hubs, servers, storage devices, compute devices, etc.), as needed to facilitate communication between the endpoint device 102 and the network computing device(s) 120, which are not shown to preserve clarity of the description.

The network computing device 120 may be embodied as any type of network traffic managing, processing, and/or forwarding device, such as a server (e.g., stand-alone, rack-mounted, blade, etc.), an enhanced network interface controller (NIC) (e.g., a host fabric interface (HFI)), a network appliance (e.g., physical or virtual), switch (e.g., a disaggregated switch, a rack-mounted switch, a standalone switch, a fully managed switch, a partially managed switch, a full-duplex switch, and/or a half-duplex communication mode enabled switch), a router, a web appliance, a distributed computing system, a processor-based system, and/or a multiprocessor system. It should be appreciated that while the illustrative system 100 includes only includes a single network computing device 120, there may be any number of additional network computing devices 120, as well any number of additional endpoint devices 102, in other embodiments.

As shown in FIG. 1, similar to the previously described endpoint device 102, the illustrative network computing device 120 includes a processor 122, an I/O subsystem 124, a memory 126, a data storage device 128, and communication circuitry 130. As such, further descriptions of the like components are not repeated herein for clarity of the description with the understanding that the description of the corresponding components provided above in regard to the endpoint device 102 applies equally to the corresponding components of the network computing device 120. Of course, in other embodiments, the network computing device 120 may include additional or alternative components, such as those commonly found in a server, router, switch, or other network device. Additionally, in some embodiments, one or more of the illustrative components may be incorporated in, or otherwise form a portion of, another component.

The illustrative communication circuitry 130 includes multiple ingress/egress ports 132 and a pipeline logic unit 134. The multiple ports 132 (i.e., input/output ports) may be embodied as any type of network port capable of transmitting/receiving network traffic to/from the network computing device 120. Accordingly, in some embodiments, the network computing device 120 may be configured to create a separate collision domain for each of the ports 132. As such, depending on the network design of the network computing device 120 and the operation mode (e.g., half-duplex, full-duplex, etc.), it should be appreciated that each of the other network computing devices 120 connected to one of the ports 132 (e.g., via an interconnect) may be configured to transfer data to any of the other network computing devices 120 at any given time, and the transmissions should not interfere, or collide.

The pipeline logic unit 134 may be embodied as any specialized device, circuitry, hardware, or combination thereof to perform pipeline logic (e.g., hardware algorithms) for performing the functions described herein. In some embodiments, the pipeline logic unit 134 may be embodied as a system-on-a-chip (SoC) or otherwise form a portion of a SoC of the network computing device 120 (e.g., incorporated, along with the processor 122, the memory 126, the communication circuitry 130, and/or other components of the network computing device 120, on a single integrated circuit chip). Alternatively, in some embodiments, the pipeline logic unit 134 may be embodied as one or more discrete processing units of the network computing device 120, each of which may be capable of performing one or more of the functions described herein. For example, the pipeline logic unit 134 may be configured to process network packets (e.g., parse received network packets, determine destination computing devices for each received network packets, forward the network packets to a particular buffer queue of a respective host buffer of the network computing device 120, etc.), perform computational functions, etc.

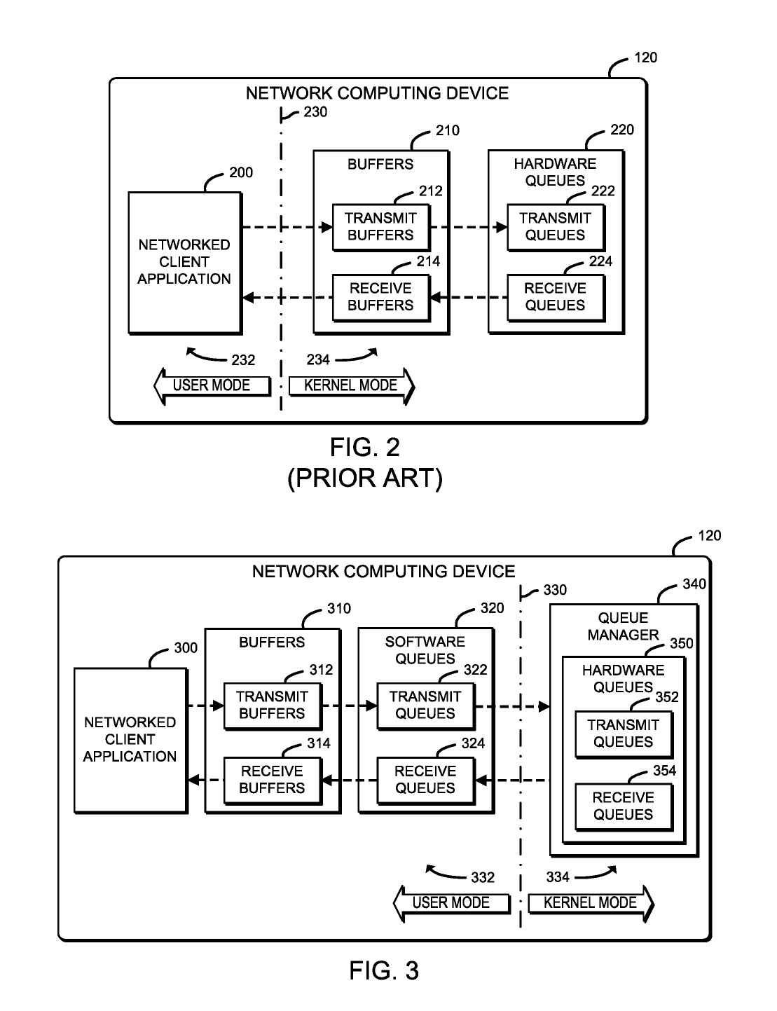

Referring now to FIG. 2, a typical I/O design of present network computing devices is shown. The illustrative typical I/O design includes a demarcation line 230 which delineates between a user mode 232 and a kernel mode 234 of the network computing device 120. It should be appreciated that kernel mode 234 is generally reserved for the lowest-level, most trusted functions of the operating system; while the executing code in user mode 232 typically has no ability to directly access hardware (e.g., the processor 122, the communication circuitry, 130, etc.) or reference memory (e.g., the memory 126, the data storage device 128, etc.) of the network computing device 120.

The user mode 232 includes a networked client application 200 and the kernel mode 322 includes buffers 210 (i.e., memory buffers) and hardware queues 220 (i.e., queues configured in hardware of the network computing device 120). The illustrative buffers 210 include transmit buffers 212 and receive buffers 214, and the illustrative hardware queues 220 include transmit queues 222 and receive queues 224. In use, inbound network traffic is received by the receive queues 224 of the hardware queues 220, forwarded to the receive buffers 214 of the buffers 210, and transmitted to the networked client application 200. Outbound network traffic is transmitted by the networked client application 200 to the transmit buffers 212 of the buffers 210, forwarded to the transmit queues 222 of the hardware queues 220, and transmitted to the appropriate destination computing device (e.g., the endpoint device 102, another network computing device 120, etc.).

Referring now to FIG. 3, similar to the illustrative typical I/O design of FIG. 2, the illustrative network computing device 120 includes a demarcation line 330 which delineates between a user mode 332 and a kernel mode 334 of the network computing device 120. Also similar to the illustrative typical I/O design of FIG. 2, the illustrative network computing device 120 of FIG. 3 additionally includes a networked client application 300. However, unlike in the typical embodiment, the buffers 310 of the illustrative network computing device 120 are located in a corresponding user mode 332. In other words, as compared to the typical I/O design embodiment of FIG. 2, the buffers 310 have been moved from kernel mode 334 to the other side of the demarcation line 330 in the I/O design of the present application. Additionally, the user mode 332 includes software queues 320.

The illustrative software queues 320 include transmit queues 322 and receive queues 324. As will be described further below, software of the network computing device 120 abstracts the hardware queues 350 of the kernel mode 334 into the software queues 320 of the user mode 332 such that the software queues 320 may be owned by either the driver (e.g., in MSI-x mode) or the PDPI client. It should be appreciated that, in some embodiments, the software queues 320 may include only transmit queues 322 or only receive queues 324. As also differentiated from the typical I/O design embodiment of FIG. 2, the hardware queues 350 (i.e., the transmit queues 352 and the receive queues 354) are still in the kernel mode 334; however, the I/O design of the present application includes a queue manager 340 that is configured to coordinate the transition of the queues to manage dissimilar network traffic flows without resetting/re-initializing hardware of the network computing device 120 (e.g., the processor 122, the memory 126, the communication circuitry 130, etc.).

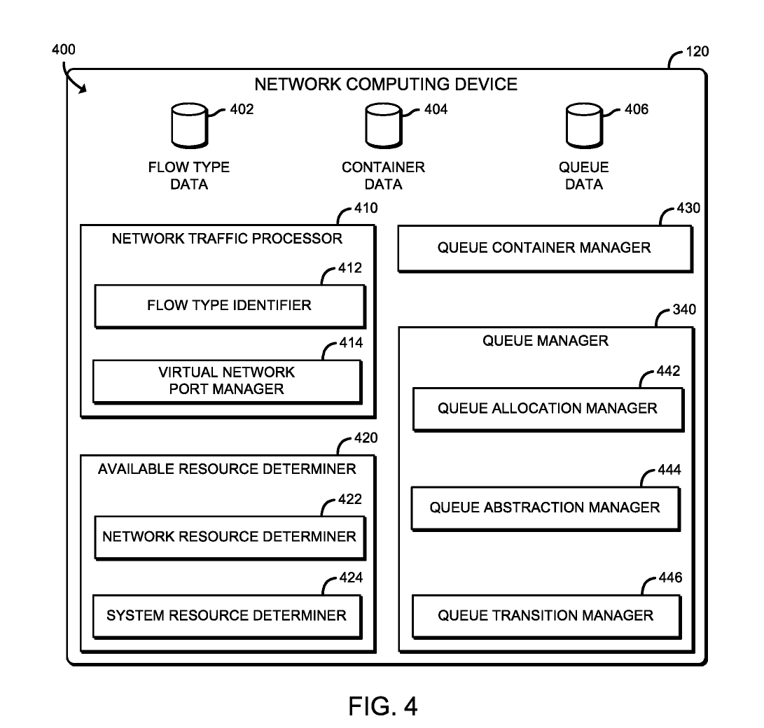

Referring now to FIG. 4, in use, the network computing device 120 establishes an environment 400 during operation. The illustrative environment 400 includes a network traffic processor 410, an available resource determiner 420, and a queue container manager 430, as well as the queue manager 310 of FIG. 3. The various components of the environment 400 may be embodied as hardware, firmware, software, or a combination thereof. As such, in some embodiments, one or more of the components of the environment 400 may be embodied as circuitry or collection of electrical devices (e.g., a network traffic processing circuit 410, an available resource determination circuit 420, a queue container management circuit 430, a queue management circuit 310, etc.).

It should be appreciated that, in such embodiments, one or more of the network traffic processing circuit 410, the available resource determination circuit 420, the queue container management circuit 430, and the queue management circuit 310 may form a portion of one or more of the processor 122, the I/O subsystem 124, the communication circuitry 130, and/or other components of the network computing device 120. Additionally, in some embodiments, one or more of the illustrative components may form a portion of another component and/or one or more of the illustrative components may be independent of one another. Further, in some embodiments, one or more of the components of the environment 400 may be embodied as virtualized hardware components or emulated architecture, which may be established and maintained by the processor 122 or other components of the network computing device 120. It should be appreciated that the network computing device 120 may include other components, sub-components, modules, sub-modules, logic, sub-logic, and/or devices commonly found in a computing device, which are not illustrated in FIG. 4 for clarity of the description.

In the illustrative environment 400, the network computing device 120 additionally includes flow type data 402, container data 404, and queue data 406, each of which may be accessed by the various components and/or sub-components of the network computing device 120. Further, each of the flow type data 402, the container data 404, and the queue data 406 may be accessed by the various components of the network computing device 120. Additionally, it should be appreciated that in some embodiments the data stored in, or otherwise represented by, each of the the flow type data 402, the container data 404, and the queue data 406 may not be mutually exclusive relative to each other. For example, in some implementations, data stored in the flow type data 402 may also be stored as a portion of one or more of the container data 404 and/or the queue data 406, or vice versa. As such, although the various data utilized by the network computing device 120 is described herein as particular discrete data, such data may be combined, aggregated, and/or otherwise form portions of a single or multiple data sets, including duplicative copies, in other embodiments.

The network traffic processor 410, which may be embodied as hardware, firmware, software, virtualized hardware, emulated architecture, and/or a combination thereof as discussed above, is configured to process network traffic. To do so, the illustrative network traffic processor 410 includes a flow type identifier 412 and a virtual network port manager 414. It should be appreciated that each of the flow type identifier 412 and the virtual network port manager 414 of the network traffic processor 410 may be separately embodied as hardware, firmware, software, virtualized hardware, emulated architecture, and/or a combination thereof. For example, the flow type identifier 412 may be embodied as a hardware component, while the virtual network port manager 414 may be embodied as a virtualized hardware component or as some other combination of hardware, firmware, software, virtualized hardware, emulated architecture, and/or a combination thereof.

The flow type identifier 412 is configured to determine a flow type associated with a particular network packet, or series of network packets. The flow type identifier 412 may be configured to determine the flow type based on a function, or service, to be performed on the network packet(s) and/or one or more properties associated with the network packet(s), such as a data type associated with the network packet(s), a destination address (e.g., an internet protocol (IP) address, a destination media access control (MAC) address, etc.) of a destination computing device, 5-tuple flow identification, etc. In some embodiments, the flow type and/or other data related thereto may be stored in the flow type data 402. It should be appreciated that, in some embodiments, a lookup may be performed (e.g., in a flow lookup table, a routing table, etc.) to determine the destination computing device.

The virtual network port manager 414 is configured to manage (e.g., create, modify, delete, etc.) connections to virtual network ports (i.e., virtual network interfaces) of the network computing device 120 (e.g., via the communication circuitry 130). It should be appreciated that, in some embodiments, the operating system kernel of the network computing device 120 may maintain a table of virtual network interfaces in memory of the network computing device 120, which may be managed by the virtual network port manager 414.

The available resource determiner 420, which may be embodied as hardware, firmware, software, virtualized hardware, emulated architecture, and/or a combination thereof as discussed above, is configured to determine available resources at a given point in time (e.g., a snapshot of available resources at the time a particular request was received). To do so, the illustrative available resource determiner 420 includes a network resource determiner 422 to determine available network resources (e.g., available bandwidth, available connections to other network computing device 120, queue congestion, latency, telemetry data, etc.) and a system resource determiner 424 to determine available system resources (e.g., available memory, available processor cores, types of installed software, I/O capabilities, queue congestion, etc.).

It should be appreciated that each of the network resource determiner 422 and the system resource determiner 424 of the available resource determiner 420 may be separately embodied as hardware, firmware, software, virtualized hardware, emulated architecture, and/or a combination thereof. For example, the network resource determiner 422 may be embodied as a hardware component, while the system resource determiner 424 may be embodied as a virtualized hardware component or as some other combination of hardware, firmware, software, virtualized hardware, emulated architecture, and/or a combination thereof.

The queue container manager 430, which may be embodied as hardware, firmware, software, virtualized hardware, emulated architecture, and/or a combination thereof as discussed above, is configured to manage (e.g., create, modify, delete, etc.) containers usable to house the software abstracted queues described herein. In some embodiments, the queue container manager 430 may be configured to create containers based on connection specific requirements, such as virtualized connections. For example, the queue container manager 430 may be configured to create one or more containers based on a number of abstracted software queues to be contained therein, such as may be based on available network and/or system resources (e.g., as may be determined by the available resource determiner 420). In some embodiments, information related to the container, such as information of an associated virtualized connection, may be stored in the container data 404.

The queue manager 310, as described above, is configured to manage the queues contained within each container the queue container manager 430 is configured to manage. To do so, the illustrative queue manager 310 includes a queue allocation manager 442, a queue abstraction manager 444, and a queue transition manager 446. In some embodiments, data related to the hardware and/or software queues described herein may be stored in the queue data 406.

It should be appreciated that each of the queue allocation manager 442, the queue abstraction manager 444, and the queue transition manager 446 of the queue manager 310 may be separately embodied as hardware, firmware, software, virtualized hardware, emulated architecture, and/or a combination thereof. For example, the queue allocation manager 442 may be embodied as a hardware component, while the queue abstraction manager 444 and/or the queue transition manager 446 may be embodied as a virtualized hardware component or as some other combination of hardware, firmware, software, virtualized hardware, emulated architecture, and/or a combination thereof.

The queue allocation manager 442 is configured to allocate memory for the hardware queues (e.g., the transmit queues 222 and the receive queues 224 of the hardware queues 220 of FIG. 3) of the network computing device 120. In some embodiments, the queue allocation manager 442 is configured to allocate queue/buffer descriptor rings, in which each descriptor indicates a location in host memory the buffer resides, as well as the size of the buffer. Additionally or alternatively, the queue allocation manager 442 is configured to allocate queues for traffic flow controls, or any other type of queue usable to perform the functions described herein.

The queue abstraction manager 444 is configured to allocate software-based structures (e.g., the transmit queues 302 and the receive queues 304 of the software queues 300 of FIG. 3) which represent abstractions of the hardware queues (e.g., the transmit queues 222 and the receive queues 224 of the hardware queues 220 of FIG. 3) of the network computing device 120. Accordingly, the abstracted queues can be owned by a software driver or the PDPI client. It should be appreciated that, in some embodiments, the queue abstraction manager 444 may only allocate abstracted transmit queues or abstracted receive queues, not both. In some embodiments, the abstracted queues may be allocated by the queue allocation manager 442. The queue abstraction manager 444 is additionally configured to assign one or more of the abstracted queues to an individual container.

The queue transition manager 446 is configured to manage the transition of the abstracted queues between two dissimilar network traffic flows (e.g., PDPI, MSI-x, etc.). For example, the queue transition manager 446 may be configured to coordinate the transition from MSI-x to PDPI with all of the affected technologies (e.g., receive side scaling (RSS), datacenter bridging (DCB), etc.) and hardware interfaces such that the network traffic may be processed until the transition has been completed. To do so, the queue transition manager 446 is configured to handle interrupt causes, configure queue contexts, assign user priorities, assign traffic classic, interface with the operating system, make hardware configuration adjustments, etc.

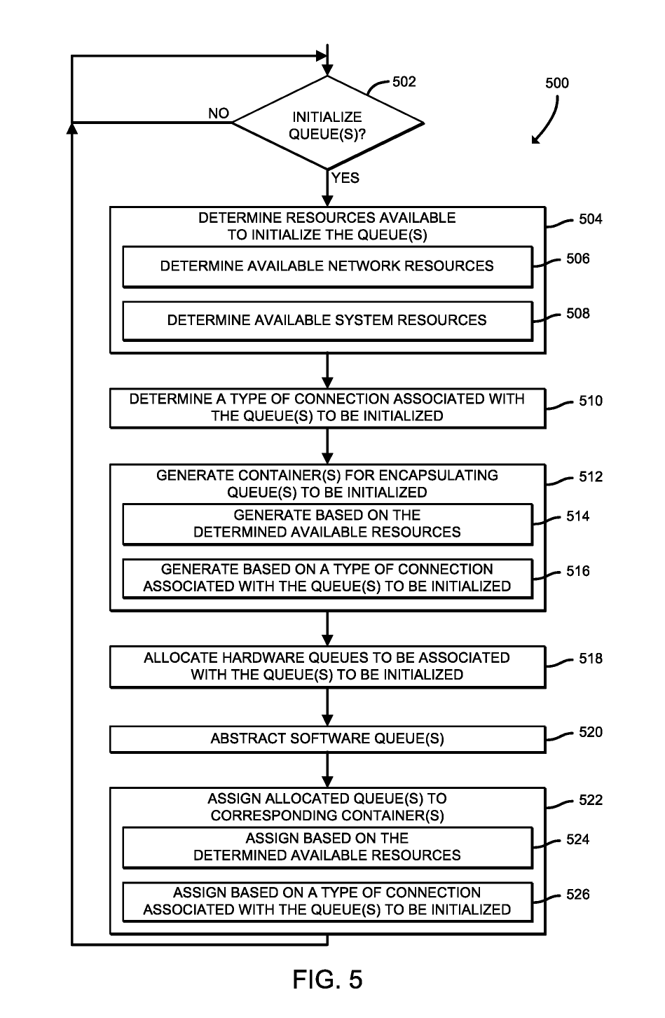

Referring now to FIG. 5, the network computing device 120 may execute a method 500 for allocating host buffer queues for network traffic processing. The method 500 begins with block 502, in which the network computing device 120 determines whether to initialize one or more queues for queuing network traffic received by the network computing device 120 and/or network traffic generated by the network computing device 120 that is to be transmitted from the network computing device 120. In some embodiments, the queue initialization may be performed during initialization of network controller hardware (e.g., the communication circuitry 130) of the network computing device 120. If the network computing device 120 determines that one or more queues are to be initialized, the method 500 advances to block 504.

In block 504, the network computing device 120 determines which resources are available to allocate an appropriate number of queues. To do so, in block 506, the network computing device 120 determines which network resources are available. The available network resources may include any information associated with the network that is usable to determine the appropriate number of queues to be allocated. For example, the available network resources may include any information related to an amount of available bandwidth, a number of available connections to other network computing device 120, queue congestion, latency values, telemetry data, etc. Additionally, in block 508, the network computing device 120 determines which system resources are available. The available system resources may include any information associated with software and/or hardware components of the network computing device 120 which are usable to determine the appropriate number of queues to be allocated. For example, the available system resources may include information related to the processor 122 (e.g., a number of available processor cores), the memory 126 (e.g., an amount of available memory), which software and versions thereof are presently installed, I/O capabilities, queue congestion, etc.).

In block 510, the network computing device 120 determines a type of connection associated with the queues to be initialized. For example, the type of connection may be a virtual network port, a physical network port, or some other type of connection. In block 512, the network computing device 120 generates one or more containers for encapsulating the queues to be initialized. To do so, in block 514, the network computing device 120 generates the containers based on the available resources determined in block 504. Additionally, in block 516, the network computing device 120 generates the containers based on the type of connection associated with the queues to be initialized, as determined in block 510.

In block 518, the network computing device 120 allocates a number of hardware queues to be associated with the queues to be initialized. In block 520, the network computing device 120 abstracts an appropriate number of software queues. It should be appreciate that the number of abstracted queues may be based on factors similar to the containers (e.g., the available resources, the type of connection, etc.), as well as services, or functions, to be performed by the network computing device 120. As described previously, the abstracted queues are structures which represent actual hardware queues (e.g., those hardware queues allocated in block 518), such as queue/buffer descriptor rings.

In block 522, the network computing device 120 assigns each of the allocated queues to a respective container. It should be appreciated that more than one queue may be assigned to a container. In block 524, the network computing device 120 assigns the allocated queues to the respective containers based on the available resources determined in block 504. Additionally, in block 526, the network computing device 120 assigns the allocated queues to the respective containers based on the type of connection associated with the queues to be initialized, as determined in block 510. It should be appreciated that such abstracted queues assigned to the respective containers can provide a direct line for a client (e.g., the networked client application 200 of FIG. 3) to the actual hardware queue (e.g., the hardware queues 220 of FIG. 3) of the network computing device 120. It should be further appreciated that additional and/or alternative queues and/or containers may be allocated post driver/hardware initialization and perform the functions as described herein.

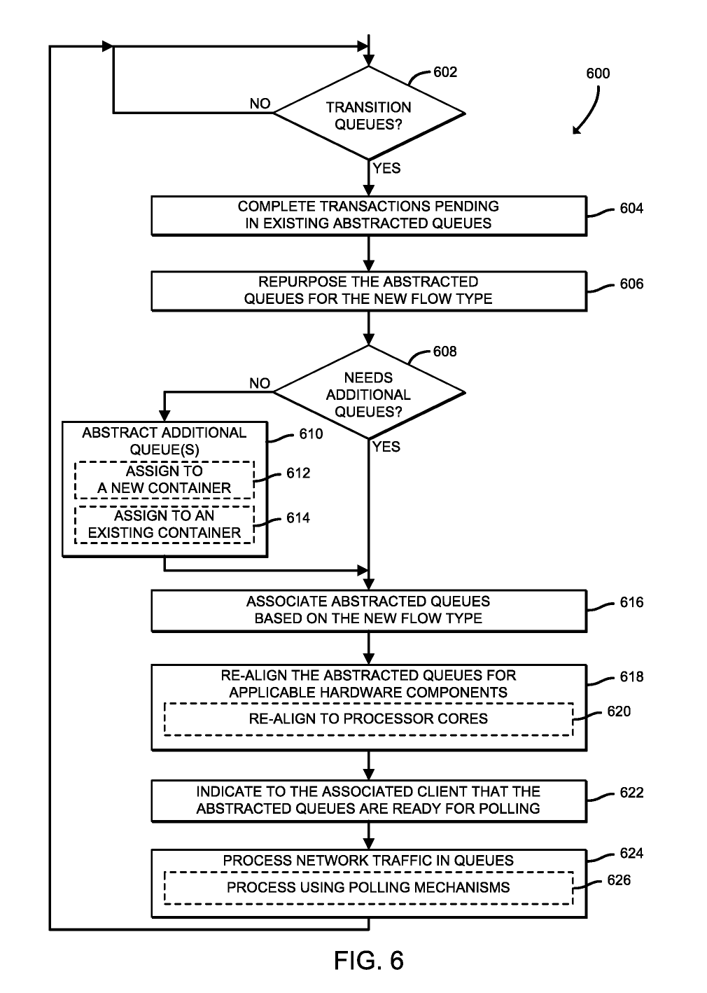

Referring now to FIG. 6, the network computing device 120 may execute a method 600 for dynamically transitioning network traffic host buffer queues. The method 600 begins with block 602, in which the network computing device 120 determines whether to transition from a present network traffic flow type to a dissimilar network traffic flow type. For example, the queues may be operating in a standard buffer list configuration mode and a new network traffic flow type set to utilize the same queues may be PDPI, such as may result from different network traffic being detected (e.g., in the hardware queues 220 of FIG. 3). In an illustrative example, the queues may be presently configured for a particular packet rate, and a change in the networked client application to which the queues have been assigned may result in a different packet rate. If the network computing device 120 determines to transition from the present network traffic flow type to the dissimilar network traffic flow type, the method 600 advances to block 604.

In block 604, the network computing device 120 completes pending transactions on existing network traffic in abstracted queues. In block 606, the network computing device 120 repurposes the abstracted queues for the new flow type that initiated the queue transition. In other words, the network computing device 120 uses previously allocated structures (e.g., memory, etc.) which represent software and/or hardware descriptor rings, rather than having to re-allocate structures/memory previously allocated to manage the other network traffic flow type. As such, an alternate set of resources (e.g., structures, memory, etc.) may be not need to be allocated. For example, hardware queue size and/or memory footprint may change, while just network traffic management may need to be only need to be momentarily paused to make such changes, which is generally a shorter period of time than is typically required to allocate an alternate set of resources.

In block 608, the network computing device 120 determines whether additional abstracted queues are needed. If so, the method 600 branches to block 610, in which the network computing device 120 abstracts one or more additional queues. To do so, the network computing device 120 may allocate the queues as previously described in the method 500 of FIG. 5. The network computing device 120 may, in block 612, assign the new queues to a new container, or, in block 614, assign the new queues to an existing container before the method 600 advances to block 616 described below.

If the network computing device 120 determines additional abstracted queues are not needed in block 608, the method 600 branches to block 616. In block 616, the network computing device 120 associates the abstracted queues based on the new flow type. For example, in a transition from MSI-x to PDPI, the network computing device 120 may associate the driver queues to the PD queues (e.g., in a 1:1:1 relationship). In block 618, the network computing device 120 realigns the queue transitions to applicable hardware components of the network computing device 120. It should be appreciated that in the context of switching between legacy and PDPI modes, the potential of losing RSS configuration exists (e.g., queue processing may not be linked to the appropriate processor or processor core). Accordingly, in some embodiments, in block 620, the network computing device 120 may realign, or re-associate, the queue transitions to the appropriate processor cores (e.g., RSS). In block 622, the network computing device 120 provides an indication (e.g., via the operating system) to the associated client (e.g., the network client application) that the abstracted queues are ready for polling (i.e., to ensure processor cores are not being starved). In block 624, the network computing device 120 processes the network traffic in the queues. For example, in some embodiments, in block 626, the network computing device 120 may process the network traffic using polling mechanisms.

It should be appreciated that, in some embodiments, at least a portion of the methods 500 and 600 may be embodied as various instructions stored on a computer-readable media, which may be executed by a processor (e.g., the processor 122), the communication circuitry 130, and/or other components of the network computing device 120 to cause the network computing device 120 to perform at least a portion of the methods 500 and 600. The computer-readable media may be embodied as any type of media capable of being read by the network computing device 120 including, but not limited to, the memory 126, the data storage device 128, other memory or data storage devices of the network computing device 120, portable media readable by a peripheral device of the network computing device 120, and/or other media.

### EXAMPLES

Illustrative examples of the technologies disclosed herein are provided below. An embodiment of the technologies may include any one or more, and any combination of, the examples described below.

Example 1 includes a network computing device for dynamically transitioning network traffic host buffers of the network computing device, the network computing device comprising one or more processors; and one or more data storage devices having stored therein a plurality of instructions that, when executed by the one or more processors, cause the network computing device to identify a queue transition event; transition, in response to having identified the queue transition event, one or more abstracted queues from a first network traffic flow type to a second network traffic flow type, wherein the abstracted queues comprise software abstractions of one or more hardware queues previously allocated by the network computing device, and wherein the first and second network traffic flow use different queue types; complete pending transactions in the abstracted queues; repurpose the abstracted queues for the second network traffic flow type to be associated with the second network traffic flow type; realign the abstracted queues to be associated with one or more hardware components of the network computing device based on the second network traffic flow type; provide a ready indication to a client associated with the abstracted queues that indicates the abstracted queues are ready for polling; and process received network traffic associated with the second network traffic flow type in the abstracted queues.

Example 2 includes the subject matter of Example 1, and wherein to identify the queue transition event comprises to detect a change in a network traffic flow type of network traffic received by the network computing device.

Example 3 includes the subject matter of any of Examples 1 and 2, and wherein the plurality of instructions further cause the network computing device to determine whether the transition requires additional abstracted queues; abstract, in response to a determination that the transition requires the additional abstracted queues, the additional abstracted queues; and assign the additional abstracted queues to a container.

Example 4 includes the subject matter of any of Examples 1-3, and wherein to assign the additional abstracted queues to the container comprises to assign the additional abstracted queues to (i) an existing container or (ii) a new container.

Example 5 includes the subject matter of any of Examples 1-4, and wherein the plurality of instructions further cause the network computing device to receive an initialization indication to initialize one or more abstracted queues; determine, in response to having received the initialization indication, available resources of the network computing device, wherein the available resources include at least one of a network resource of a plurality of available network resources associated with a network to which the network computing device is connected and a system resource of a plurality of system resources associated with a hardware component or software resource of the network computing device; determine a type of connection to be associated with the one or more abstracted queues; abstract the one or more abstracted queues based on one or more hardware queues previously allocated in a memory of the network computing device based on the determined available resources; and assign the one or more abstracted queues to one or more containers usable to store the one or more abstracted queues based on the type of connection.

Example 6 includes the subject matter of any of Examples 1-5, and wherein to abstract the one or more abstracted queues comprises to allocate a data structure in software that represents the one or more hardware queues.

Example 7 includes the subject matter of any of Examples 1-6, and wherein the network resources include at least one of an amount of available bandwidth, a number of available connections connecting the network computing device to other network computing devices, a queue congestion value, a latency value, or telemetry data.

Example 8 includes the subject matter of any of Examples 1-7, and wherein the system resources include at least one of a number of available processor cores, an amount of available memory, a software application type, a software application version, an input/output capabilities, or a queue congestion value.

Example 9 includes the subject matter of any of Examples 1-8, and wherein to realign the abstracted queues for the one or more hardware components of the network computing device comprises to realign the abstracted queues for one or more cores of a processor of the network computing device.

Example 10 includes the subject matter of any of Examples 1-9, and wherein to process the network traffic associated with the second network traffic flow type in the abstracted queues comprises to process the network traffic using one or more polling mechanisms.

Example 11 includes the subject matter of any of Examples 1-10, and wherein the one or more hardware queues comprise one or more queue descriptor rings.

Example 12 includes the subject matter of any of Examples 1-11, and wherein the one or more hardware queues are managed by a kernel mode of the network computing device.

Example 13 includes the subject matter of any of Examples 1-12, and wherein the one or more abstracted queues are managed by a user mode of the network computing device.

Example 14 includes the subject matter of any of Examples 1-13, and wherein the one or more abstracted queues include at least one of one or more abstracted transmit queues and one or more abstracted receive queues.

Example 15 includes a network computing device for dynamically transitioning network traffic host buffers of the network computing device, the network computing device comprising a network traffic processor to identify a queue transition event; and a queue manager to (i) transition, in response to having identified the queue transition event, one or more abstracted queues from a first network traffic flow type to a second network traffic flow type, wherein the abstracted queues comprise software abstractions of one or more hardware queues previously allocated by the network computing device, and wherein the first and second network traffic flow use different queue types, (ii) complete pending transactions in the abstracted queues, (iii) repurpose the abstracted queues for the second network traffic flow type to be associated with the second network traffic flow type, (iv) realign the abstracted queues to be associated with one or more hardware components of the network computing device based on the second network traffic flow type, and (v) provide a ready indication to a client associated with the abstracted queues that indicates the abstracted queues are ready for polling, wherein the network traffic processor is further to process received network traffic associated with the second network traffic flow type in the abstracted queues.

Example 16 includes the subject matter of Example 15, and wherein to identify the queue transition event comprises to detect a change in a network traffic flow type of network traffic received by the network computing device.

Example 17 includes the subject matter of any of Examples 15 and 16, and wherein the queue manager is further to (i) determine whether the transition requires additional abstracted queues, (ii) abstract, in response to a determination that the transition requires the additional abstracted queues, the additional abstracted queues, and (iii) assign the additional abstracted queues to a container.

Example 18 includes the subject matter of any of Examples 15-17, and wherein to assign the additional abstracted queues to the container comprises to assign the additional abstracted queues to (i) an existing container or (ii) a new container.

Example 19 includes the subject matter of any of Examples 15-18, and wherein the queue manager is further to receive an initialization indication to initialize one or more abstracted queues, further comprising an available resource determiner to determine, in response to having received the initialization indication, available resources of the network computing device, wherein the available resources include at least one of a network resource of a plurality of available network resources associated with a network to which the network computing device is connected and a system resource of a plurality of system resources associated with a hardware component or software resource of the network computing device, wherein the queue manager is further to (i) determine a type of connection to be associated with the one or more abstracted queues, (ii) abstract the one or more abstracted queues based on one or more hardware queues previously allocated in a memory of the network computing device based on the determined available resources, and (iii) assign the one or more abstracted queues to one or more containers usable to store the one or more abstracted queues based on the type of connection.

Example 20 includes the subject matter of any of Examples 15-19, and wherein to abstract the one or more abstracted queues comprises to allocate a data structure in software that represents the one or more hardware queues.

Example 21 includes the subject matter of any of Examples 15-20, and wherein the network resources include at least one of an amount of available bandwidth, a number of available connections connecting the network computing device to other network computing devices, a queue congestion value, a latency value, or telemetry data.

Example 22 includes the subject matter of any of Examples 15-21, and wherein the system resources include at least one of a number of available processor cores, an amount of available memory, a software application type, a software application version, an input/output capabilities, or a queue congestion value.

Example 23 includes the subject matter of any of Examples 15-22, and wherein to realign the abstracted queues for the one or more hardware components of the network computing device comprises to realign the abstracted queues for one or more cores of a processor of the network computing device.

Example 24 includes the subject matter of any of Examples 15-23, and wherein to process the network traffic associated with the second network traffic flow type in the abstracted queues comprises to process the network traffic using one or more polling mechanisms.

Example 25 includes the subject matter of any of Examples 15-24, and wherein the one or more hardware queues comprise one or more queue descriptor rings.

Example 26 includes the subject matter of any of Examples 15-25, and wherein the one or more hardware queues are managed by a kernel mode of the network computing device.

Example 27 includes the subject matter of any of Examples 15-26, and wherein the one or more abstracted queues are managed by a user mode of the network computing device.

Example 28 includes the subject matter of any of Examples 15-27, and wherein the one or more abstracted queues include at least one of one or more abstracted transmit queues and one or more abstracted receive queues.

Example 29 includes a method for dynamically transitioning network traffic host buffers of the network computing device, the method comprising identifying, by a network computing device, a queue transition event; transitioning, by the network computing device and in response to having identified the queue transition event, one or more abstracted queues from a first network traffic flow type to a second network traffic flow type, wherein the abstracted queues comprise software abstractions of one or more hardware queues previously allocated by the network computing device, and wherein the first and second network traffic flow use different queue types; completing, by the network computing device, pending transactions in the abstracted queues; repurposing, by the network computing device, the abstracted queues for the second network traffic flow type to be associated with the second network traffic flow type; realign, by the network computing device, the abstracted queues to be associated with one or more hardware components of the network computing device based on the second network traffic flow type; providing, by the network computing device, a ready indication to a client associated with the abstracted queues that indicates the abstracted queues are ready for polling; and processing, by the network computing device, received network traffic associated with the second network traffic flow type in the abstracted queues.

Example 30 includes the subject matter of Example 29, and wherein identifying the queue transition event comprises detecting a change in a network traffic flow type of network traffic received by the network computing device.

Example 31 includes the subject matter of any of Examples 29 and 30, and further including determining, by the network computing device, whether the transition requires additional abstracted queues; abstracting, by the network computing device and in response to a determination that the transition requires the additional abstracted queues, the additional abstracted queues; and assigning, by the network computing device, the additional abstracted queues to a container.

Example 32 includes the subject matter of any of Examples 29-31, and wherein assigning the additional abstracted queues to the container comprises assigning the additional abstracted queues to (i) an existing container or (ii) a new container.

Example 33 includes the subject matter of any of Examples 29-32, and further including receiving, by the network computing device, an initialization indication to initialize one or more abstracted queues; determining, by the network computing device and in response to having received the initialization indication, available resources of the network computing device, wherein the available resources include at least one of a network resource of a plurality of available network resources associated with a network to which the network computing device is connected and a system resource of a plurality of system resources associated with a hardware component or software resource of the network computing device; determining, by the network computing device, a type of connection to be associated with the one or more abstracted queues; abstracting, by the network computing device, the one or more abstracted queues based on one or more hardware queues previously allocated in a memory of the network computing device based on the determined available resources; and assigning, by the network computing device, the one or more abstracted queues to one or more containers usable to store the one or more abstracted queues based on the type of connection.

Example 34 includes the subject matter of any of Examples 29-33, and wherein abstracting the one or more abstracted queues comprises allocating a data structure in software that represents the one or more hardware queues.

Example 35 includes the subject matter of any of Examples 29-34, and wherein determining the available network resources includes determining at least one of an amount of available bandwidth, a number of available connections connecting the network computing device to other network computing devices, a queue congestion value, a latency value, or telemetry data.

Example 36 includes the subject matter of any of Examples 29-35, and wherein determining the available system resources includes determining at least one of a number of available processor cores, an amount of available memory, a software application type, a software application version, an input/output capabilities, or a queue congestion value.

Example 37 includes the subject matter of any of Examples 29-36, and wherein realigning the abstracted queues for the one or more hardware components of the network computing device comprises realigning the abstracted queues for one or more cores of a processor of the network computing device.

Example 38 includes the subject matter of any of Examples 29-37, and wherein processing the network traffic associated with the second network traffic flow type in the abstracted queues comprises processing the network traffic using one or more polling mechanisms.

Example 39 includes the subject matter of any of Examples 29-38, and wherein abstracting the one or more abstracted queues based on one or more hardware queues comprises abstracting the one or more abstracted queues based on one or more queue descriptor rings.

Example 40 includes the subject matter of any of Examples 29-39, and further including managing the one or more hardware queues by a kernel mode of the network computing device.

Example 41 includes the subject matter of any of Examples 29-40, and further including managing the one or more abstracted queues by a user mode of the network computing device.

Example 42 includes the subject matter of any of Examples 29-41, and wherein abstracting the one or more abstracted queues comprises abstracting at least one of one or more abstracted transmit queues and one or more abstracted receive queues.

Example 43 includes a network computing device comprising a processor; and a memory having stored therein a plurality of instructions that when executed by the processor cause the network computing device to perform the method of any of Examples 29-42.

Example 44 includes one or more machine readable storage media comprising a plurality of instructions stored thereon that in response to being executed result in a network computing device performing the method of any of Examples 29-42.

Example 45 includes a network computing device for dynamically transitioning network traffic host buffers of the network computing device, the network computing device comprising means for identifying a queue transition event; means for transitioning, in response to having identified the queue transition event, one or more abstracted queues from a first network traffic flow type to a second network traffic flow type, wherein the abstracted queues comprise software abstractions of one or more hardware queues previously allocated by the network computing device, and wherein the first and second network traffic flow use different queue types; means for completing pending transactions in the abstracted queues; means for repurposing the abstracted queues for the second network traffic flow type to be associated with the second network traffic flow type; means for realign the abstracted queues to be associated with one or more hardware components of the network computing device based on the second network traffic flow type; means for providing a ready indication to a client associated with the abstracted queues that indicates the abstracted queues are ready for polling; and means for processing received network traffic associated with the second network traffic flow type in the abstracted queues.

Example 46 includes the subject matter of Example 45, and wherein the means for identifying the queue transition event comprises means for detecting a change in a network traffic flow type of network traffic received by the network computing device.

Example 47 includes the subject matter of any of Examples 45 and 46, and further including means for determining whether the transition requires additional abstracted queues; means for abstracting, in response to a determination that the transition requires the additional abstracted queues, the additional abstracted queues; and means for assigning the additional abstracted queues to a container.

Example 48 includes the subject matter of any of Examples 45-47, and wherein the means for assigning the additional abstracted queues to the container comprises means for assigning the additional abstracted queues to (i) an existing container or (ii) a new container.

Example 49 includes the subject matter of any of Examples 45-48, and further including means for receiving an initialization indication to initialize one or more abstracted queues; means for determining, in response to having received the initialization indication, available resources of the network computing device, wherein the available resources include at least one of a network resource of a plurality of available network resources associated with a network to which the network computing device is connected and a system resource of a plurality of system resources associated with a hardware component or software resource of the network computing device; means for determining a type of connection to be associated with the one or more abstracted queues; means for abstracting the one or more abstracted queues based on one or more hardware queues previously allocated in a memory of the network computing device based on the determined available resources; and means for assigning the one or more abstracted queues to one or more containers usable to store the one or more abstracted queues based on the type of connection.

Example 50 includes the subject matter of any of Examples 45-49, and wherein the means for abstracting the one or more abstracted queues comprises means for allocating a data structure in software that represents the one or more hardware queues.

Example 51 includes the subject matter of any of Examples 45-50, and wherein the means for determining the available network resources includes means for determining at least one of an amount of available bandwidth, a number of available connections connecting the network computing device to other network computing devices, a queue congestion value, a latency value, or telemetry data.

Example 52 includes the subject matter of any of Examples 45-51, and wherein the means for determining the available system resources includes means for determining at least one of a number of available processor cores, an amount of available memory, a software application type, a software application version, an input/output capabilities, or a queue congestion value.

Example 53 includes the subject matter of any of Examples 45-52, and wherein the means for realigning the abstracted queues for the one or more hardware components of the network computing device comprises means for realigning the abstracted queues for one or more cores of a processor of the network computing device.

Example 54 includes the subject matter of any of Examples 45-53, and wherein the means for processing the network traffic associated with the second network traffic flow type in the abstracted queues comprises means for processing the network traffic using one or more polling mechanisms.

Example 55 includes the subject matter of any of Examples 45-54, and wherein the means for abstracting the one or more abstracted queues based on one or more hardware queues comprises means for abstracting the one or more abstracted queues based on one or more queue descriptor rings.

Example 56 includes the subject matter of any of Examples 45-55, and further including means for managing the one or more hardware queues by a kernel mode of the network computing device.

Example 57 includes the subject matter of any of Examples 45-56, and further including means for managing the one or more abstracted queues by a user mode of the network computing device.

Example 58 includes the subject matter of any of Examples 45-57, and wherein the means for abstracting the one or more abstracted queues comprises means for abstracting at least one of one or more abstracted transmit queues and one or more abstracted receive queues.

1. A network computing device for dynamically transitioning network traffic host buffers of the network computing device, the network computing device comprising:
one or more processors; and
one or more data storage devices having stored therein a plurality of instructions that, when executed by the one or more processors, cause the network computing device to:
identify a queue transition event;
transition, in response to having identified the queue transition event, one or more abstracted queues from a first network traffic flow type to a second network traffic flow type, wherein the abstracted queues comprise software abstractions of one or more hardware queues previously allocated by the network computing device, and wherein the first and second network traffic flow use different queue types;
complete pending transactions in the abstracted queues;
repurpose the abstracted queues for the second network traffic flow type to be associated with the second network traffic flow type;
realign the abstracted queues to be associated with one or more hardware components of the network computing device based on the second network traffic flow type;
provide a ready indication to a client associated with the abstracted queues that indicates the abstracted queues are ready for polling; and
process received network traffic associated with the second network traffic flow type in the abstracted queues.

2. The network computing device of claim 1, wherein to identify the queue transition event comprises to detect a change in a network traffic flow type of network traffic received by the network computing device.

3. The network computing device of claim 1, wherein the plurality of instructions further cause the network computing device to:
determine whether the transition requires additional abstracted queues;
abstract, in response to a determination that the transition requires the additional abstracted queues, the additional abstracted queues; and
assign the additional abstracted queues to a container.

4. The network computing device of claim 1, wherein to assign the additional abstracted queues to the container comprises to assign the additional abstracted queues to (i) an existing container or (ii) a new container.

5. The network computing device of claim 1, wherein the plurality of instructions further cause the network computing device to:
receive an initialization indication to initialize one or more abstracted queues;
determine, in response to having received the initialization indication, available resources of the network computing device, wherein the available resources include at least one of a network resource of a plurality of available network resources associated with a network to which the network computing device is connected and a system resource of a plurality of system resources associated with a hardware component or software resource of the network computing device;
determine a type of connection to be associated with the one or more abstracted queues;
abstract the one or more abstracted queues based on one or more hardware queues previously allocated in a memory of the network computing device based on the determined available resources; and
assign the one or more abstracted queues to one or more containers usable to store the one or more abstracted queues based on the type of connection.

6. The network computing device of claim 5, wherein to abstract the one or more abstracted queues comprises to allocate a data structure in software that represents the one or more hardware queues.

7. The network computing device of claim 5, wherein the network resources include at least one of an amount of available bandwidth, a number of available connections connecting the network computing device to other network computing devices, a queue congestion value, a latency value, or telemetry data.

8. The network computing device of claim 5, wherein the system resources include at least one of a number of available processor cores, an amount of available memory, a software application type, a software application version, an input/output capabilities, or a queue congestion value.

9. The network computing device of claim 1, wherein to realign the abstracted queues for the one or more hardware components of the network computing device comprises to realign the abstracted queues for one or more cores of a processor of the network computing device.

10. The network computing device of claim 1, wherein to process the network traffic associated with the second network traffic flow type in the abstracted queues comprises to process the network traffic using one or more polling mechanisms.

11. One or more computer-readable storage media comprising a plurality of instructions stored thereon that in response to being executed cause a network computing device to:
identify a queue transition event;
transition, in response to having identified the queue transition event, one or more abstracted queues from a first network traffic flow type to a second network traffic flow type, wherein the abstracted queues comprise software abstractions of one or more hardware queues previously allocated by the network computing device, and wherein the first and second network traffic flow use different queue types;
complete pending transactions in the abstracted queues;
repurpose the abstracted queues for the second network traffic flow type to be associated with the second network traffic flow type;
realign the abstracted queues to be associated with one or more hardware components of the network computing device based on the second network traffic flow type;
provide a ready indication to a client associated with the abstracted queues that indicates the abstracted queues are ready for polling; and
process received network traffic associated with the second network traffic flow type in the abstracted queues.

12. The one or more computer-readable storage media of claim 11, wherein to identify the queue transition event comprises to detect a change in a network traffic flow type of network traffic received by the network computing device.

13. The one or more computer-readable storage media of claim 11, wherein the plurality of instructions further cause the network computing device to:
determine whether the transition requires additional abstracted queues, (ii) abstract, in response to a determination that the transition requires the additional abstracted queues, the additional abstracted queues; and
assign the additional abstracted queues to a container.

14. The one or more computer-readable storage media of claim 11, wherein to assign the additional abstracted queues to the container comprises to assign the additional abstracted queues to (i) an existing container or (ii) a new container.

15. The one or more computer-readable storage media of claim 11, wherein the plurality of instructions further cause the network computing device to:
receive an initialization indication to initialize one or more abstracted queues;
determine, in response to having received the initialization indication, available resources of the network computing device, wherein the available resources include at least one of a network resource of a plurality of available network resources associated with a network to which the network computing device is connected and a system resource of a plurality of system resources associated with a hardware component or software resource of the network computing device;
determine a type of connection to be associated with the one or more abstracted queues;
abstract the one or more abstracted queues based on one or more hardware queues previously allocated in a memory of the network computing device based on the determined available resources; and
assign the one or more abstracted queues to one or more containers usable to store the one or more abstracted queues based on the type of connection.

16. The one or more computer-readable storage media of claim 15, wherein to abstract the one or more abstracted queues comprises to allocate a data structure in software that represents the one or more hardware queues.

17. The one or more computer-readable storage media of claim 15, wherein the network resources include at least one of an amount of available bandwidth, a number of available connections connecting the network computing device to other network computing devices, a queue congestion value, a latency value, or telemetry data.

18. The one or more computer-readable storage media of claim 15, wherein the system resources include at least one of a number of available processor cores, an amount of available memory, a software application type, a software application version, an input/output capabilities, or a queue congestion value.

19. The one or more computer-readable storage media of claim 15, wherein to realign the abstracted queues for the one or more hardware components of the network computing device comprises to realign the abstracted queues for one or more cores of a processor of the network computing device.

20. The one or more computer-readable storage media of claim 15, wherein to process the network traffic associated with the second network traffic flow type in the abstracted queues comprises to process the network traffic using one or more polling mechanisms.

21. A network computing device for dynamically transitioning network traffic host buffers of the network computing device, the network computing device comprising:
means for identifying a queue transition event;
means for transitioning, in response to having identified the queue transition event, one or more abstracted queues from a first network traffic flow type to a second network traffic flow type, wherein the abstracted queues comprise software abstractions of one or more hardware queues previously allocated by the network computing device, and wherein the first and second network traffic flow use different queue types;
means for completing pending transactions in the abstracted queues;
means for repurposing the abstracted queues for the second network traffic flow type to be associated with the second network traffic flow type;
means for realign the abstracted queues to be associated with one or more hardware components of the network computing device based on the second network traffic flow type;
means for providing a ready indication to a client associated with the abstracted queues that indicates the abstracted queues are ready for polling; and
means for processing received network traffic associated with the second network traffic flow type in the abstracted queues.

22. The network computing device of claim 21, wherein the means for identifying the queue transition event comprises means for detecting a change in a network traffic flow type of network traffic received by the network computing device.

23. The network computing device of claim 21, further comprising:
means for determining whether the transition requires additional abstracted queues;
means for abstracting, in response to a determination that the transition requires the additional abstracted queues, the additional abstracted queues; and
means for assigning the additional abstracted queues to a container.

24. The network computing device of claim 21, wherein the means for assigning the additional abstracted queues to the container comprises means for assigning the additional abstracted queues to (i) an existing container or (ii) a new container.

25. The network computing device of claim 21, further comprising:
means for receiving an initialization indication to initialize one or more abstracted queues;
means for determining, in response to having received the initialization indication, available resources of the network computing device, wherein the available resources include at least one of a network resource of a plurality of available network resources associated with a network to which the network computing device is connected and a system resource of a plurality of system resources associated with a hardware component or software resource of the network computing device;
means for determining a type of connection to be associated with the one or more abstracted queues;
means for abstracting the one or more abstracted queues based on one or more hardware queues previously allocated in a memory of the network computing device based on the determined available resources; and
means for assigning the one or more abstracted queues to one or more containers usable to store the one or more abstracted queues based on the type of connection.
